(19) United States
(12) Patent Application Publication
(10) Pub. No.: US 2025/0131937 A1
(43) Pub. Date: Apr. 24, 2025

(54) SYSTEMS AND METHODS FOR PROVIDING A SHARED AMBIANCE IN VIRTUAL MEETINGS

(71) Applicant: Microsoft Technology Licensing, LLC, Redmond, WA (US)

(72) Inventors: Reginald Walton MARTIN, IV, Irvine, CA (US); Eric Edmond THOMASIAN, Los Angeles, CA (US); Amer Aref HASSAN, Kirkland, WA (US)

(21) Appl. No.: 18/383,344

(22) Filed: Oct. 24, 2023

(51) Int. Cl. G10L 21/028; G06F 3/16; G10L 15/06; G10L 21/0216

(52) U.S. Cl. CPC G10L 21/028; G06F 3/165; G10L 15/063; G10L 21/0216; G10L 2015/0635

(57) ABSTRACT

Systems and methods are disclosed herein for providing a shared ambiance in a virtual meeting. In some instances, systems receive audio signals from a set of audio inputs corresponding to a plurality of participants in a virtual meeting. Each audio signal includes a voice component and a background noise component. Systems isolate the background noise component from the voice component for each received audio signal and then determine an ambiance score for each isolated background noise component. Based on the determined ambiance scores, systems select a particular background noise component from the isolated background noise components and transmit the particular background noise component to a set of audio outputs corresponding to the plurality of participants in order to provide a shared ambiance for the plurality of participants in the virtual meeting.

### BACKGROUND

Virtual meetings have become an integral part of modern communication, especially in the context of remote work and global collaboration. Virtual meetings are typically facilitated by various software platforms that allow multiple participants to connect and interact in real-time through audio and video channels. The quality of these virtual meetings is largely dependent on the clarity and consistency of the audio and video signals transmitted and received by the participants.

One of the challenges in virtual meetings is the management of background noise. Each participant in a virtual meeting typically joins from a different location, each with its distinct ambient noise. This ambient noise can include a wide range of sounds, such as traffic noise, office chatter, household sounds, or even silence. These diverse background noises can create an inconsistent and sometimes distracting audio experience for the participants. On the other hand, the presence of some ambient sounds can help create a more natural and immersive virtual meeting experience. For example, in a virtual social gathering, the background noise of a café or a park can contribute to the atmosphere of the event and make the virtual experience feel more like a real-life social gathering.

Current virtual meeting platforms often employ noise suppression or noise canceling technologies to minimize the impact of background noise on the audio quality of the meeting. These technologies work by identifying and reducing the volume of sounds that are not part of the primary audio signal, typically the voice of the speaker. While effective in reducing unwanted noise, these technologies can also result in an audio experience that feels artificial and lacks the natural ambiance of in-person meetings.

In view of the foregoing, there is a need for improved methods and systems that provide improved user experience during virtual meetings with multiple participants.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

The disclosed embodiments are directed toward systems and methods for providing a controlled and shared ambiance in a virtual meeting. In some instances, systems receive audio signals from a set of audio inputs corresponding to a plurality of participants in a virtual meeting. Each audio signal includes a voice component and a background noise component corresponding to a different participant. Systems isolate the background noise component from the voice component for each received audio signal and then determine an ambiance score for each isolated background noise component. Based on the determined ambiance scores, systems select a particular background noise component from the isolated background noise components to use as the controlled and consistent background ambient noise to use for the duration of the meeting. In order to provide the shared ambiance for the plurality of participants in the virtual meeting, the systems transmit the particular background noise component to a set of audio outputs corresponding to the plurality of participants.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS AND REFERENCE TO APPENDIX

In order to describe the manner in which the above-recited and other advantages and features can be obtained, a more particular description of the subject matter briefly described above will be rendered by reference to specific embodiments that are illustrated in the appended drawings. Understanding that these drawings depict only typical embodiments and are not, therefore, limiting in scope, embodiments will be described and explained with additional specificity and detail through the use of the accompanying drawings in which:

FIG. 1 illustrates an example embodiment of a multiple-participant virtual meeting with an inconsistent background ambiance experience.

FIG. 2 illustrates an example embodiment of isolating individual background noise components from each participant in a multiple-participant virtual meeting.

FIG. 3 illustrates an example embodiment of selecting a particular background noise component as the shared background ambiance for all participants.

FIG. 4 illustrates an example embodiment of transmitting the selected background noise component of FIG. 3 to the audio outputs of all participants in the virtual meeting.

FIG. 5 illustrates an example embodiment of generating ambiance scores for each individual background noise component.

FIG. 6 illustrates an example embodiment for generating a shared background noise component.

FIG. 7 illustrates another example embodiment for generating a shared background noise component.

FIG. 8 illustrates an example embodiment of a user interface configured to receive user input to control various settings for providing a shared ambiance in a virtual meeting.

FIG. 9 illustrates one embodiment of a flow diagram having a plurality of acts associated with a method for providing a shared ambiance between participants of a virtual meeting.

FIG. 10 illustrates an example computing environment in which a computing system incorporates and/or is utilized to perform disclosed aspects of the disclosed embodiments.

### DETAILED DESCRIPTION

The disclosed embodiments can be utilized to facilitate improvements in the user experience of virtual meetings with multiple participants. In particular, systems and methods are included herein which select and utilize a shared ambiance audio for all participants in a virtual meeting.

As will be described in more detail herein, many technical problems exist with conventional systems for facilitating shared virtual meetings between multiple participants. Some of these technical problems are associated with conventional systems' inability to mitigate discontinuities in the background noise components that are broadcast from different user environments. This problem is caused, in part, because many conventional systems are currently configured to only switch audio inputs during the meeting between the different users and to transmit their entire audio signal, which includes a voice component and a background noise component.

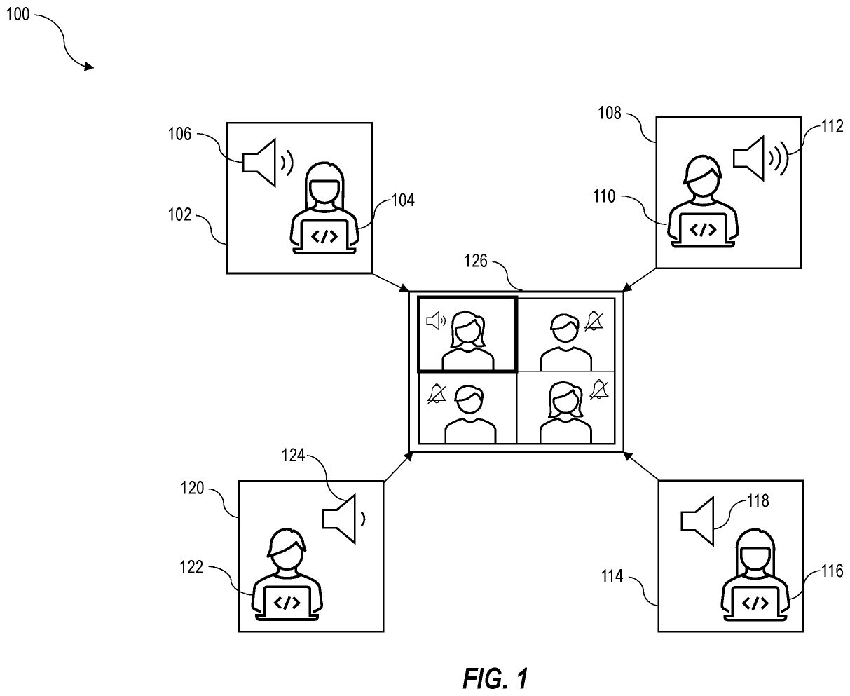

While some conventional systems may provide background noise suppression or cancellation, they still suffer technical problems associated with the suppression or cancellation resulting from the inability to effectively provide a seamless user experience for all participants involved. These technical problems include sound gaps in the ambient noise presented when switching between different speakers and the inconsistent use of different ambient noise obtained from the different user environments. Some of the problems associated with conventional meeting systems are described further in reference to FIG. 1 and throughout the following disclosure.

In light of the aforementioned technical problems, the disclosed embodiments are directed to technical solutions that can be used to help address some of these technical problems. For example, the disclosed embodiments are directed to systems and methods that isolate each user's background noise component and select a particular background noise component as a shared ambiance audio to use consistently for all participants in the virtual meeting. This can help address the switching problem mentioned above.

Additionally, the disclosed embodiments achieve the technical benefit provided by machine learning which selects the best background noise component based on different ambient scores associated with the different background components identified at each of the different user locations so as to provide a shared ambience that is most likely to be suitable for the meeting and meeting participants based on learned preferences of the different participants and the contexts of the meeting. These, along with many other technical benefits, will become more apparent through the description provided herein.

Some of these technical benefits are especially apparent in virtual meetings associated with different goals or contexts. For example, the proposed solution offers several potential benefits that can enhance the user experience during a video conference for a collaborative team meeting, or even a casual catching up with friends. One such benefit is the facilitation of warmer conversations. By creating a shared ambient background, the system can help to ease tension and make silences less awkward. This can make the video conference feel more like an in-person social gathering where all participants share a common location and where the ambient noise of the environment can help to create a more relaxed and natural atmosphere.

Another potential benefit of the proposed solution is the ability to spotlight background sounds. This feature allows the system to bring a participant's background noise into the foreground, making it a topic of conversation. For example, if a participant is in a coffee shop, the system could amplify the ambient noise of the coffee shop and play it in all participants' audio. This could spark a conversation about the coffee shop, creating a more engaging and interactive video conference experience.

In some of the disclosed alternative embodiments, the proposed solutions can also facilitate synchronized musical events. By extracting and enhancing the background noise from each participant's audio into a common shared ambience, the system can create a shared musical background that all participants can enjoy. This could be particularly useful for musicians who want to practice remotely together. By creating a shared musical background, the system can help to synchronize the musicians' performances, making the practice session feel more like an in-person jam session.

### INTRODUCTION

To provide the technical benefits described above, the disclosed embodiments aim to enhance the virtual meeting experience by managing ambient noise. This is achieved by receiving audio signals from multiple participants in a virtual meeting. Each audio signal comprises two components: a voice component and a background noise component. The voice component refers to the spoken words of the participant, while the background noise component refers to any ambient sounds present in the participant's environment other than the spoken utterances of the participant. These ambient sounds can include traffic noise, animal sounds, office chatter, household sounds, talking by people other than the meeting participants and/or even silence.

Once the audio signals are received, the voice component and the background noise component for each signal are separated. This separation is achieved through a process that identifies and isolates the voice component from the background noise component. The separation of these components beneficially allows for the individual analysis and manipulation of the background noise. As described herein, the separation of the background noise components from the voice components can be performed with trained machine-learning models that are trained on training data sets that include pairings of different types of background noises and voice components.

Following the separation of the components, the background noise components are analyzed to determine an ambiance score for each. The ambiance score is a measure of the suitability of the background noise for the virtual meeting. It is determined based on a variety of factors, including but not limited to, the stability of the volume, the consistency of the sound, and the absence of detectable and/or discernable words in the background noise. The analysis of the background noise components may involve the use of machine learning models trained to identify high-quality and context-relevant background noise components. The machine learning models are also trained to score the different background noises for suitability for different types of meetings based on contexts associated with the meeting (e.g., a casual friend meeting vs. a formal business collaboration meeting, a lecture, and so forth). User preferences based on user inputs and heuristics can also be used as inputs to the machine learning models that are trained on such inputs to generate ambiance scores for the different background components that are extracted.

Once the ambiance scores have been determined, a particular background noise component is selected. This selection is preferably based on the ambiance scores, with the background noise component having the highest ambiance score being selected as the background noise component for the shared ambiance audio. The selection process takes into account various considerations, such as cultural, geographical, and linguistic factors, to ensure that the selected background noise is suitable for all participants in the virtual meeting.

In some instances, a combination of two or more of the background noises are selected and used to generate a mixed or merged ambiance.

In some alternative embodiments, a user input provided by one or more of the participants can also be used to override the selected background noise component(s) to be used. Additionally, or alternatively, the user input provided can also be used to select which background component will be used as the ambient noise or be the basis for selecting which method will be used to select, generate, or modify the background noise component(s).

Finally, the selected optimum background noise component is amplified and provided to each participant's audio output. If multiple background noises are selected for a mixed experience, then the different background noises can be selected and provided to each participant's audio output concurrently at the selected amplification levels.

The amplification process, in part, involves increasing the volume of the selected background noise component to a level that is audible to all participants. The amplified background noise is then provided to each participant's audio output, thereby simulating a shared background experience for all participants in the virtual meeting. This shared background experience helps to create a more natural and immersive virtual meeting experience that is shared in a cohesive manner among all of the meeting participants. Accordingly, the following figure descriptions provide additional details on these features.

### Conventional Systems

Attention will first be directed to FIG. 1, which illustrates an example embodiment of a multiple-participant virtual meeting with an inconsistent background ambiance experience. For example, multiple participants (e.g., user 104, user 110, user 114, and user 122) are participating in a virtual meeting 126 from their own personal devices. In many scenarios, each user is joining the meeting from a different environment that has its own background noises. As shown in FIG. 1, user 104 is in environment 102 with background noise 106, user 110 is in environment 108 with background noise 112, user 114 is in environment 114 with background noise 118, and user 122 is in environment 120 with background noise 124.

As additional examples, user 104 may be participating from a quiet office in which the background noise 106 is limited to the hum of the air conditioning. User 110 may be participating from a crowded co-working space where the background noise 112 consists of lots of different people talking and moving around in the co-working space. User 116 may be joining the virtual meeting from their home where the background noise 118 includes a dog or child that is making spontaneous loud noises. As another example, user 122 may be participating in the meeting at a café that is relatively quiet but has light music playing that is part of the background noise 124.

Typically, each user will take turns speaking during the virtual meeting. To avoid interruptions in transmitting an audio signal from a particular user while he or she is speaking, only one user will have their audio output on while the other users will have their own audio outputs on mute until it is their turn to speak. While this solution mitigates some of the issues like interruptions from another user's audio signal while one user is speaking, it still results in a disjointed user experience for the participants. This is because every time a new user is speaking, each user will now not only hear the voice component of the new user but also that user's background noises as well.

Some of this can be mitigated by having each user utilize an audio input and/or output device that is configured for background noise suppression or cancellation. Additionally, some software is available that also provides background noise suppression or noise cancellation capabilities during transmission or streaming of different speakers. However, this will still cause a disjointed user experience, or in some cases, an unnatural user experience, when users switch between talking in the virtual meetings and during which there are sound gaps with no noise. Thus, to provide improved user experiences with multiple participant virtual meetings, some disclosed embodiments described herein are directed to providing a shared ambiance audio for all participants in the virtual meeting that remains consistent, regardless of which participant is speaking.

### Shared Ambiance Experience

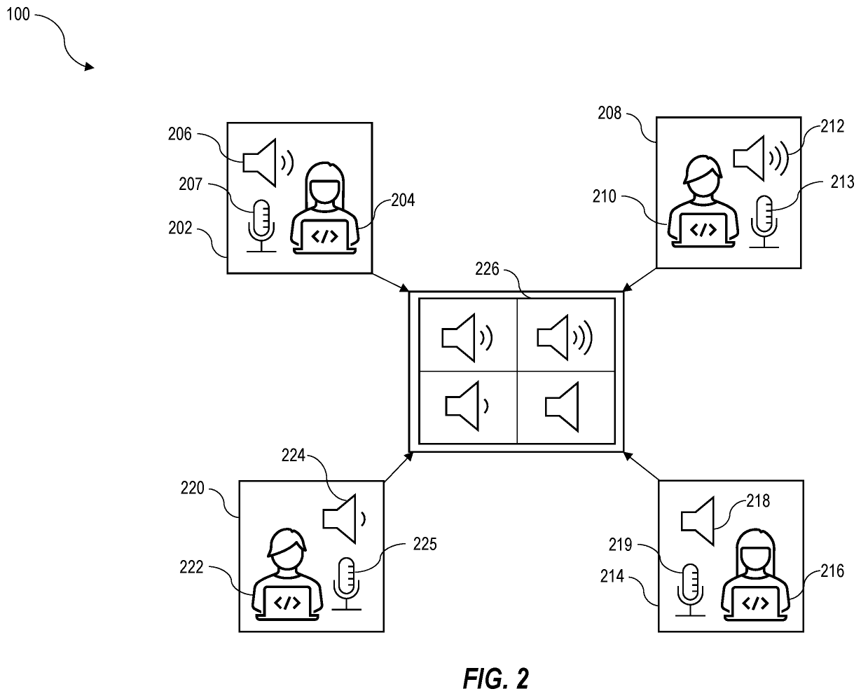

Attention will now be directed to FIG. 2, which illustrates an example embodiment of isolating individual background noise components from each participant in a multiple-participant virtual meeting, which allows the system to subsequently provide a shared ambiance audio in the virtual meeting.

In the process of enhancing a virtual meeting experience, systems are configured for receiving audio signals from multiple participants in a virtual meeting. Each participant in the meeting sends an audio signal that is captured by their respective audio input devices, such as microphones. These audio signals are then transmitted over a network to a central server or directly to the other participants in the meeting, depending on the architecture of the virtual meeting platform. It will be appreciated any scoring processes or background component processing can be performed at the client (i.e., within the same computing system as the user's audio input/output devices). For example, in some instances, the client system will perform the scoring for the user's isolated background noise component (or any other background noise components that it has access to) and transmit the ambiance score to the server. In such cases, the server can receive one or more ambiance scores to use in the background noise component selection process, as described in more details below. Alternatively, both the scoring and background noise component modification and/or selection can occur at the client system.

Each audio signal that is received consists of two distinct components: a voice component and a background noise component. The voice component refers to the spoken words of the participant. This is the primary audio signal that the participant intends to transmit to the other participants in the meeting. The voice component is typically characterized by distinct patterns of sound waves that correspond to the participant's speech.

The background noise component, on the other hand, refers to any ambient sounds that are present in the participant's environment at the time of the meeting. These sounds are inadvertently captured by the participant's audio input device along with the voice component. The background noise component can include a wide variety of sounds, depending on the participant's environment. For example, it could include sounds such as traffic noise from a nearby road, office chatter from other people in the same workspace, household sounds such as a television playing in the background, or even the sound of silence in a quiet room.

It is worth noting that the background noise component is not limited to unwanted or disruptive sounds. It can also include pleasant or desirable ambient sounds that contribute to the atmosphere of the virtual meeting. For example, in a virtual social gathering, the background noise component could include the sound of soft music playing in the background, the chatter of other people at the same event, or the ambient sounds of a café or a park.

As shown in FIG. 2, each user is associated with both a background noise component and a voice component. For example, user 204 (joining from environment 202) is associated with background noise component 206 and a voice component 207. User 210 (joining from environment 208) is associated with background noise component 212 and voice component 213. User 216 (joining from environment 214) is associated with background noise component 218 and voice component 219. User 222 (joining from environment 220) is associated with background noise component 224 and voice component 225.

After each user is identified, along with the audio signal for each user comprising both the background noise component and the voice component, the background noise components from each user are isolated from their corresponding voice components (e.g., the isolated background noise components 226). The separation process is achieved through a combination of signal processing techniques and algorithms designed to distinguish between the voice component and the background noise component. These techniques may include spectral subtraction, statistical modeling, and machine learning algorithms, among others. The goal of these techniques is to isolate the voice component, which is characterized by distinct patterns of sound waves corresponding to the participant's speech, from the background noise component, which encompasses all other ambient sounds present in the participant's environment.

In some instances, the isolating or separating process is only done initially within a first portion of the virtual meeting. In some instances, this separation of voice and background noise components is not a static process but is dynamically adjusted throughout the duration of the virtual meeting. As the ambient sounds in a participant's environment can change over time, the separation process is continuously updated to accurately reflect the current state of each participant's audio signal. This dynamic adjustment allows the systems to respond in real-time to changes in the participants' environments, ensuring that the shared background experience remains consistent and immersive throughout the virtual meeting.

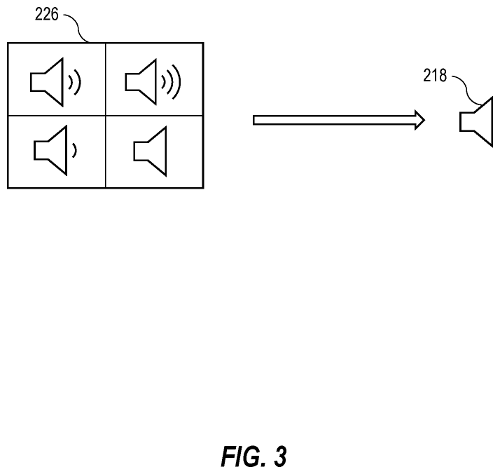

As shown in FIG. 3, after all of the background noise components have been separated or otherwise isolated, one particular background noise component (e.g., background noise component 218) is selected from the set of different isolated background noise components 226.

For example, once the voice component and the background noise component have been successfully separated, they can be individually analyzed and manipulated. The voice component can be processed to enhance the clarity and intelligibility of the participant's speech, while the background noise component can be analyzed to determine its suitability as a shared background experience for the virtual meeting. Then, one or more of the background components can be selected, amplified or otherwise modified and shared to all of the different meeting participants.

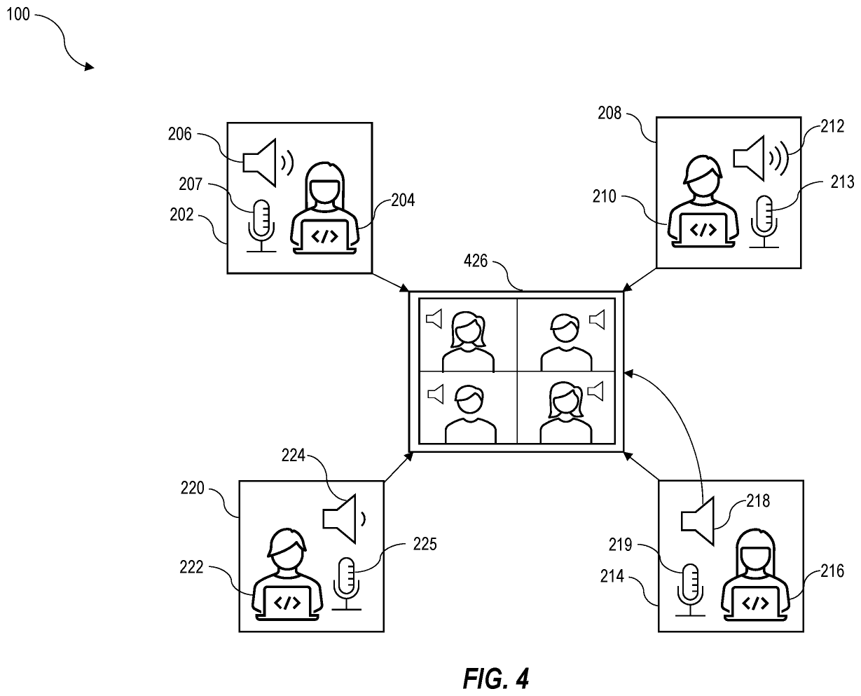

As shown in FIG. 4, after the particular background noise component (e.g., background noise component 218) is selected, the particular background noise component 218 is transmitted to each audio output of the virtual meeting 426. This involves transmitting the amplified background noise component over the network to each participant's audio output device, such as speakers or headphones. The transmission of the amplified background noise component is synchronized with the transmission of the voice components of the audio signals to ensure a seamless audio experience for the participants.

By providing the selected background noise component to each participant's audio output, the virtual meeting is able to simulate a shared ambiance for all participants in the virtual meeting. This shared ambiance helps to create a more natural and immersive virtual meeting experience by emulating the feel of a natural in-person social gathering, regardless of which user is speaking or contributing a voice component to the virtual meeting. This shared background experience is a central aspect of the disclosed embodiments and plays a pivotal role in enhancing the virtual meeting experience for all participants.

### Ambiance Scoring

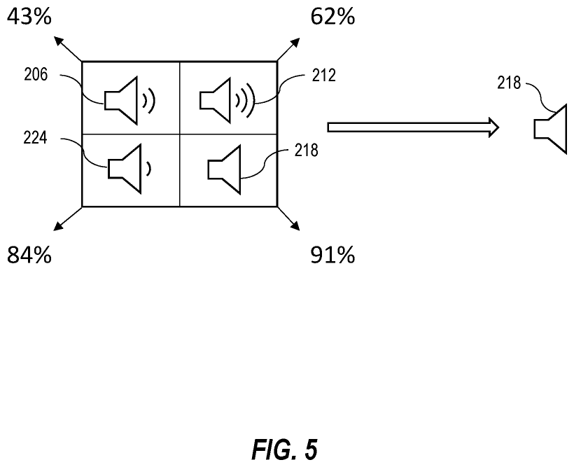

The process of selecting which background noise component to use as the shared ambiance audio can be accomplished in many different ways. For example, attention will now be directed to FIG. 5, which illustrates an example embodiment of generating ambiance scores for each individual background noise component and selecting a background noise component based on the different ambiance scores. In some embodiments, an ambiance score is generated for each isolated background noise component.

Following the separation of the voice and background noise components, the separated background noise components are analyzed to determine an ambiance score for each background noise component. The ambiance score is a measure of the suitability of the background noise for the virtual meeting. It is determined based on a variety of factors, including but not limited to, the stability of the volume, the consistency of the sound, and the absence of detectable and/or discernable words in the background noise.

The stability of the volume refers to the degree to which the volume of the background noise remains constant over time. A stable volume is desirable as it provides a consistent audio experience for the participants. Sudden changes in volume can be distracting and can disrupt the flow of the meeting. Therefore, in some instances, background noise components with a stable volume are given a higher ambiance score.

The consistency of the sound refers to the uniformity of the sound waves in the background noise. A consistent sound is one that does not have abrupt changes in frequency or amplitude. Consistent sounds are less likely to interfere with the voice components of the audio signals and are therefore more suitable for the virtual meeting based on some particular contexts of the virtual meeting. As such, background noise components with a consistent sound are given a higher ambiance score.

The absence of detectable or discernable words in the background noise is another factor considered in determining the ambiance score. detectable and discernable words in the background noise can be confusing and can interfere with the understanding of the spoken words in the voice components. Therefore, background noise components that omit background sounds or that do not contain any discernable or detectable words are given a higher ambiance score.

In addition to these factors, the analysis of the separated background noise components may involve the use of one or more machine learning models trained to identify, categorize and score background noise components based on a large dataset of audio signals from previous virtual meetings based on the attributes of the background noise components and the contexts of different meetings.

The models use pattern recognition and statistical analysis to determine the characteristics of background noise components that are associated with a positive virtual meeting experience. These characteristics are then used to calculate the ambiance score for each background noise component based on quality and suitability of the background noise components for different meetings. The machine learning models can also be updated based on user input and preferences or other user feedback on the model's performance in generating ambiance scores, selecting a background noise component, and providing the shared ambiance experience in the virtual meeting.

Through this analysis process, the system is able to objectively evaluate the suitability of each background noise component for the virtual meeting. This allows for the selection of a background noise component that enhances the virtual meeting experience for all participants. This also allows for the selection of background noise component that provides a positive virtual meeting experience for a particular context associated with the virtual meeting.

In some instances, the system is configured to determine the context of the virtual meeting. The context can be associated with a goal of the virtual meeting (e.g., catching up with friends, presenting, teaching, or collaborate on a project) or desired experience or based on other factors, such as a relationship between participants (e.g., friends, family, co-workers, presenter vs. attendees, etc.) The system is able to determine the context of the meeting using different techniques. In some instances, the system receives user input that defines what the context of the meeting is. The user could indicate from what organization the participants are from (or each participant could self-identify). User input could also define whether the virtual meeting is formal or informal (e.g., a board meeting vs. a team check-in).

Additionally, or alternatively, the system is able to automatically detect a context of the virtual meeting, based on attributes such as: a title of the event, identifying participants invited to and/or attending the meeting, the total number of participants in the meeting, external documents linked to the meeting invitation (e.g., supporting materials, meeting agenda, linked emails, etc.).

In some instances, natural language processing models are used to interpret an intent of a meeting based on a provided meeting agenda and/or other content that the natural language processing models are trained to discern context from. In such instances, certain keywords identified in the meeting agenda could help to determine the context of the meeting. For example, a “munch and mingle” might correspond to a mixer or networking event that would benefit from light background music. Alternatively, a keyword like “report” may indicate a more formal setting, in which the virtual meeting would benefit from a shared ambiance that is quiet. In some instances, the system can also analyze attributes of each participant's background noise component and determine a context from those attributes. The system is also able to use a combination of both (i) user input and (ii) automatically detected attributes to determine the context.

The context of the virtual meeting can also take into consideration factors relevant to the cultural, geographical, or linguistic features of the virtual meeting and its participants. For example, in some cultures, work meetings should always be formal (i.e., resulting in higher ambiance scores for quiet, stable background noise components). Regarding geographical factors, if a majority of participants are in the same location (maybe in-person) with one or two participants joining remotely, the shared ambiance may be weighted more heavily to the preferences or current environment of the participants who are in person.

Different contexts include: a casual virtual get-together of friends (wherein the virtual meeting is enhanced by simulating a real-world location such as a coffee shop or outdoor patio), a presentation (wherein the virtual meeting is enhanced by selecting the presenter's background noise component for the attendees and/or selecting the attendee's background noises for the presenting user); a collaborative team meeting (wherein the virtual meeting is enhanced by providing a shared quiet ambiance); a music lesson (where the background noise component is an accompaniment track), or other context of the virtual meeting. In some instances, the system is configured to train different models on different contexts and then select the model for generating the ambiance scores based on the desired context of the virtual meeting.

Accordingly, the scoring and selection of background noise components to use for the shared ambiance audio can include quality attributes of the different background noise components, as well as contexts of the virtual meetings, and/or user preferences. The trained machine learning models can use any combination of the foregoing inputs that they have been trained on to score and select the different background noise components for use in the shared ambiance experiences of the virtual meetings.

As shown in FIG. 5, background noise component 206 corresponds to an ambiance score of 45%, background noise component 212 corresponds to an ambiance score of 62%, background noise component 218 corresponds to an ambiance score of 91%, and background noise component 224 corresponds to an ambiance score of 84%. In some instances, the system selects the background noise component with the highest ambiance score to be used as the shared ambiance audio for the virtual meeting. For example, as shown in FIG. 5, because background noise component 218 corresponds to the highest ambiance score (e.g., 91%) of the isolated background noise components, background noise component 218 is selected as the shared ambiance audio and is transmitted to set of audio outputs for the virtual meeting participants.

The selection process takes into account various considerations to ensure that the selected background noise is suitable for all participants in the virtual meeting. These considerations include cultural, geographical, and linguistic factors. For instance, the cultural factor may consider the cultural background of the participants and select a background noise that is culturally appropriate or familiar. The geographical factor may consider the geographical location of the participants and select a background noise that is representative of that location. The linguistic factor may consider the language spoken by the participants and select a background noise that does not interfere with the understanding of that language.

In some instances, the selection process may apply weights to certain factors more heavily than other factors based on the type or attributes of the virtual meeting when determining ambiance scores. For example, in virtual meetings, a particular participant may be the designated moderator or the creator of the event, in which case, their background noise component may receive a boost in the ambiance score, or their user input may be weighted more heavily than other participants' user input for the virtual meeting, or be the sole user input used in determining which background noise component is selected.

In some instances, the system identifies a pre-determined set of rules for the virtual meeting based on the identified context of the virtual meeting. Additionally, the system may be able to modify the set of rules based on user input from one or more participants in the virtual meeting, or based on identifying an attribute that is identified to be in conflict with the set of rules, or rule in the set of rules. Additionally, or alternatively, based on identifying a particular context of the virtual meeting, the system may apply a different scoring schema to the isolated background noise components for different contexts.

In some instances, there may be ambiance scoring factors that are context-independent—such as audio input sound quality (e.g., does the sound have static or other audio artifacts introduced by the audio input device?) or consistency of volume (e.g., inconsistent volume may be cumbersome for a participant or the system to have to constantly readjust the volume of a particular background noise component).

The machine learning models that are used to generate the ambiance scores are trained on these aforementioned factors (context-dependent and/or context-independent) in order to provide improved ambiance scores. By generating improved ambiance scores, the system also is able to improve its selection process based on those improved ambiance scores.

In determining the ambiance scores, in some instances, each factor or attribute that has been identified relating to the virtual meeting and its participants may be scored individually, such that the ambiance score is an average of the different factors. In situations where some factors are weighted more heavily than others, the ambiance score is a weighted average. In some instances, each background noise component begins with a base ambiance score that is either increased or decreased by a certain percentage or increment depending on whether the factor or attribute will positively impact the suitability of the background component as the shared ambiance audio or will negatively impact the suitability of the background component.

It will be appreciated that different combinations of rules and weights may be used to apply weights to the different ambiance scores to reflect their determined suitability for the online meeting, based on contexts and other factors being considered by the systems when generating the scores and that are distinguishing between the different background noises, as described herein.

In some cases, the selection of the background noise component can be based on a majority of the participants' background noise components. For example, if a majority of the participants are in a quiet office environment, the background noise component that is representative of a quiet office environment may be selected as the optimum background noise component. This approach ensures that the selected background noise component is representative of the majority of the participants' environments, thereby enhancing the shared background experience for the majority of the participants.

In some embodiments, an input query is presented to the different meeting participants to select or vote on the ambiance environment they desire from the different ambiance environments associated with the different participants. Then, the systems will select the desired background component(s) to use based on the user inputs to the input query.

It is worth noting that, in some instances, the selection process is not a static process but is dynamically adjusted throughout the duration of the virtual meeting. As the ambient sounds in the participants' environments can change over time, the selection process is continuously updated to accurately reflect the current state of each participant's background noise component. This dynamic adjustment allows the method to respond in real-time to changes in the participants' environments and user inputs, ensuring that the shared background experience remains consistent and immersive throughout the virtual meeting.

### Mixed Background Noise

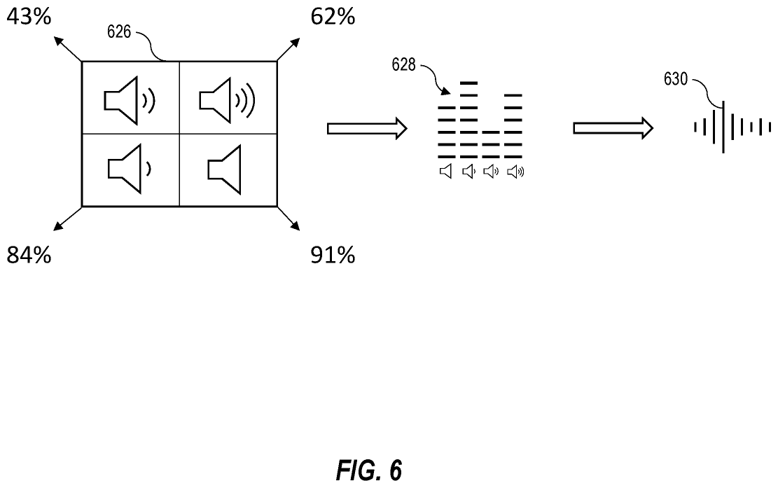

Attention will now be directed to FIG. 6, which illustrates an alternate example embodiment for generating a shared background noise component. For example, in some embodiments, the background noise component that is used for the shared ambiance audio of the virtual meeting is comprised of a mixture of one or more of the isolated background noise components 626. The isolated background noise components 626 can be mixed in different ways. In some instances, the isolated background noise components 626 are mixed equally. In other instances, the isolated background noise components 626 are weighted according to a weighting scheme 628 and then mixed according to the weighting scheme 628. Based on weighting the isolated background noise components, a mixed background noise component 630 is generated. This mixed background noise component 630 can then be transmitted to the audio output of each participant in order to provide a shared ambiance during the virtual meeting.

When ambiance scores are available for the isolated background noise components (as shown in FIG. 6), the weighting scheme is proportional to the ranking of the different ambiance scores (i.e., the isolated background noise components with higher ambiance scores are weighted more heavily than isolated background noise components with lower ambiance scores). Additionally, or alternatively, the weighting scheme is determined by user input and/or can be dynamically adjusted in real-time via the user input.

In some instances, the weighting scheme 628 is generated by a machine learning model trained to generate weighting schemes based on different attributes of the virtual meeting. For example, the machine learning model is trained to recognize a context of the virtual meetings, receive any user input defining settings of the virtual meeting, and/or analyze different attributes of each isolated background noise component in order to generate a customized weighting scheme for the virtual meeting in real-time. In some instances, the mixed background noise component 630 is generated once at the beginning of the meeting. Additionally, or alternatively, it is generated periodically or continuously, for example, in response to detecting a change in any of the previous model inputs used to generate a previous weighting scheme.

Some embodiments are also directed to real-time mixing of the different background components of each user, in which the system selectively allows certain noises at times to be amplified from different users' environments in order to be incorporated into the shared ambiance experience.

### Modified Background Noise

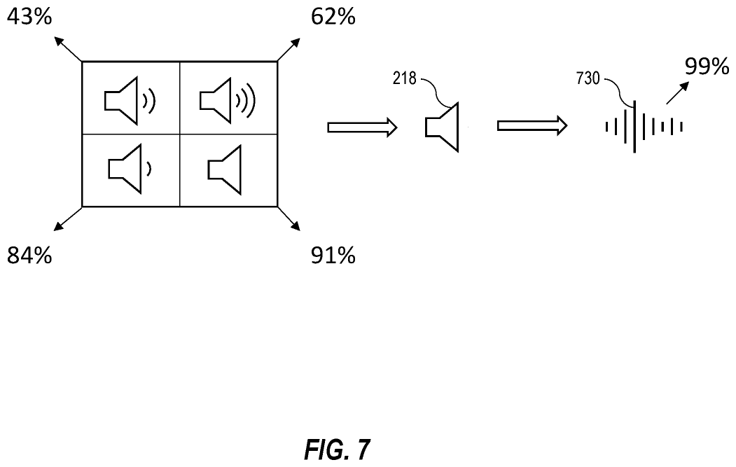

Attention will now be directed to FIG. 7, which illustrates another example embodiment for generating a shared background noise component based on augmenting an isolated background noise component to achieve a higher ambiance score. For example, as shown in FIG. 7, background noise component 218 corresponds with a 91% ambiance score. Because this is the highest ambiance score, background noise component 218 is selected as the shared ambiance audio for the virtual meeting. However, in some instances, the background noise component 218 is modified (i.e., augmented or enhanced) and then rescored. If the new ambiance score (e.g., 99%) is higher than the previous ambiance score (e.g., 91%), then the modified background noise component 730 will be used as the shared ambiance audio, as shown in FIG. 7.

The background noise components can be modified in several ways. In some instances, some noises or attributes of the background noise component (e.g., static, abrupt, or loud noises, street traffic, etc.) that lead to lower quality of the shared ambiance experience are suppressed while noises or attributes (e.g., background music, ocean waves, etc.) that lead to higher quality of the shared ambiance experience are enhanced. The system determines which noises or attributes will lead to higher or lower quality of the shared ambiance experience based on a particular context of the virtual meeting. Additionally, or alternatively, the background noise components are modified by augmenting the isolated background noise component with third-party noises or attributes (i.e., adding in light background music) that are either pre-recorded or synthesized sounds. As described above, the modified background noise component 730 can then be used as the shared ambiance audio for the virtual meeting.

It should be appreciated that, in some instances, the system will use the same background noise component that was selected initially as the shared ambiance audio throughout the duration of the virtual meeting. In some instances, the background noise component is updated or regenerated periodically or continuously throughout the meeting. Additionally, or alternatively, the system can switch between different types of background noise components (e.g., switching between a particular isolated background noise component 218, a mixed background noise component 630, and/or a modified background noise component 730.

### Personalized Ambiance Experience

Some embodiments are also directed to a continuous ambiance experience for each user that may not be shared with other users. For example, in some instances, each user is associated with a preferred ambiance experience. In such instances, the isolated background noises of the virtual meeting are scored (e.g., with a personalize ambiance score) for each user based on each user's preferred ambiance experience (e.g., if there are four participants, each isolated background noise component will be scored four different times-one for each participant). Then, the isolated background noise component with the highest personalized ambiance score is selected for each user.

The selected background noise component for each user is transmitted to the user's audio output without being transmitted to other audio outputs. Because the background noise components are isolated from voice components, as different users are speaking, the ambiance experience for a particular user remains continuous throughout the meeting because only one isolated background noise component will be transmitted to that user's audio output.

In some alternative configurations, the user can elect to have their own background noise component used as the continuous ambiance experience, can elect to utilize a different user's background noise component, can elect to have a mixture of background noise components, and/or can elect to have a modified and/or enhanced background noise component. This user selected background noise can be provided consistently throughout the meeting at the user's system, even though it may or may not be shared with other meeting participants.

### User Interfaces

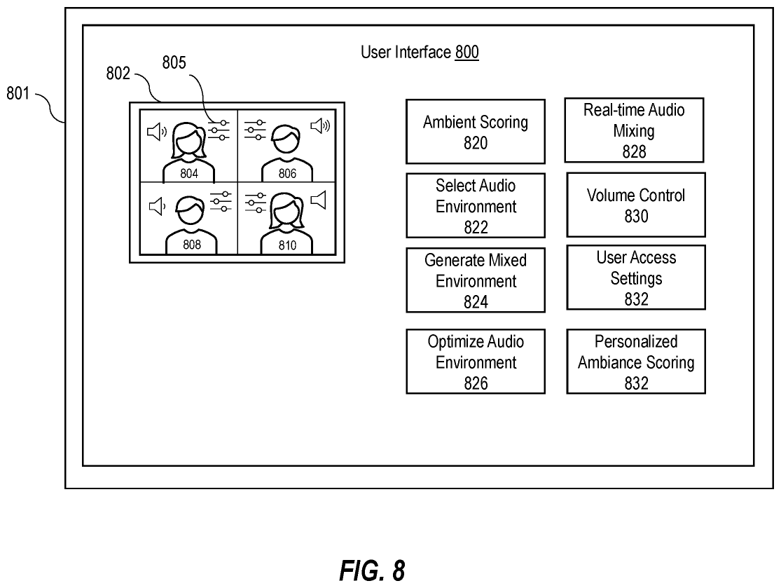

As described above, there are different ways in which user input can be used to facilitate selection and/or adjustment of the shared or continuous ambiance experience for users in a virtual meeting. Attention will now be directed to FIG. 8, which illustrates an example embodiment of a user interface configured to receive user input to control various settings for providing a shared ambiance in a virtual meeting. As shown in FIG. 8, user interface 800 is displayed on the audio-visual display screen 801. In a first location, a window 802 displays the virtual meeting view, including a box streaming each user's participation (e.g., user 804, user 806, user 808, and user 810) in the meeting. In some instances, there is also a volume control 830 (see also, user volume control 805) that can be tuned to adjust one or more different user's voice components and/or background noise components.

Accordingly, the modification process can involve adjusting the volume of the selected optimum background noise component. The volume adjustment directly influences the audibility of the background noise to the participants. The goal of the volume adjustment is to ensure that the background noise is clearly audible to all participants without overpowering the voice components of the audio signals. This balance is carefully maintained to ensure that the shared background experience enhances the virtual meeting experience without causing any distraction or discomfort to the participants.

The volume adjustment is achieved through a combination of signal processing techniques and algorithms designed to adjust the volume of the audio signal. These techniques may include dynamic range compression, automatic gain control, and volume normalization, among others. The goal of these techniques is to adjust the volume of the selected background noise component to a level that is suitable for the virtual meeting. This involves increasing or decreasing the volume of the background noise component based on the determined ambiance score and the preferences of the participants.

By adjusting the volume of the selected optimum background noise component, the system is able to further enhance the shared background experience for all participants in the virtual meeting. This allows for a more personalized and comfortable virtual meeting experience, as the background noise can be adjusted to suit the preferences of the participants. This volume adjustment beneficially enhances the virtual meeting experience for all participants.

The user interface 800 is configured to receive user input related to ambient scoring 820, for selecting an audio environment 822, for generating a mixed environment 824, and for optimizing an audio environment 826. The user interface 800 is also configured to receive user input for real-time audio mixing 828.

Users can also define or adjust user access settings 832 (i.e., which users have access to different attributes of the virtual meeting and/or shared ambiance experience). For example, in some instances, users may be able to opt in or out of a shared ambiance experience, while in other instances, the attributes of the virtual meeting are defined by an administrative user. It should be appreciated that this user interface can also be used for generating personalized ambiance scores (e.g., personalized ambiance scoring 832) to provide a personalized, continuous ambiance experience for each user.

User interface 800 can be integrated into the virtual meeting platform and can be accessed by one or more of the participants during the virtual meeting, based on the user access settings. The interface can include various controls for adjusting the volume, frequency, and other characteristics of the amplified optimum background noise component. For example, a participant may wish to lower the volume of the background noise or to filter out specific types of noises that they find distracting.

Once the user inputs are received, they are processed and used to modify the background noise component in real-time. This modification process involves adjusting the volume, frequency, and other characteristics of the background noise component based on the received user inputs. In some instances, the modification process is dynamically adjusted throughout the duration of the virtual meeting, allowing for real-time adjustments to the shared background experience based on the preferences of the participants.

By allowing participants to adjust the background noise component used for the shared ambiance audio, the disclosed embodiments provide a more personalized and comfortable virtual meeting experience. Participants can adjust the background noise to suit their personal preferences and comfort levels, thereby enhancing their engagement and satisfaction with the virtual meeting.

### Example Methods

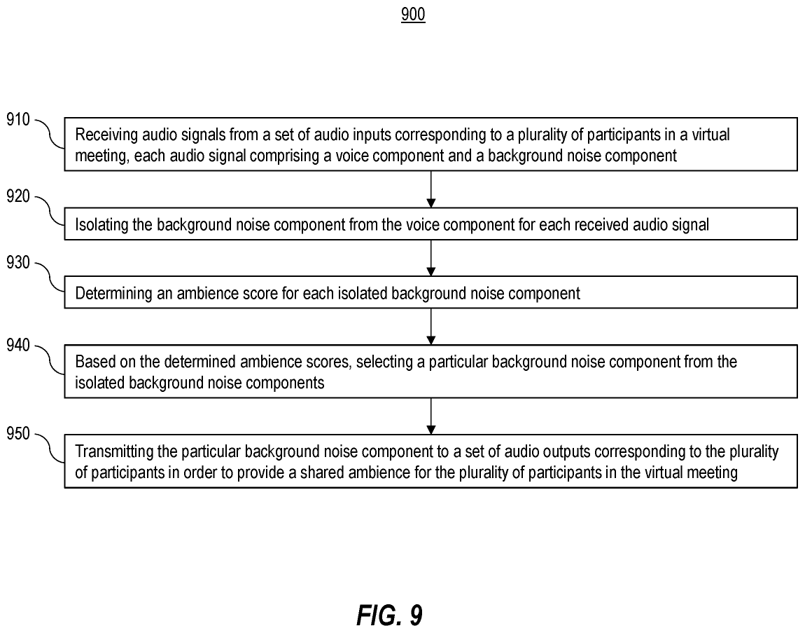

Attention will now be directed to FIG. 9, which illustrates a flow diagram or method 800 that includes various acts (act 910, act 920, act 930, act 940, and act 950) associated with exemplary methods that can be implemented by computing system 1010 for providing a shared ambiance in a virtual meeting. The computing system includes a plurality of audio input devices, a plurality of audio output devices, a processor, and a hardware storage device storing computer-executable instructions that are executable by the processor to cause the computing system to perform various acts as described below.

A first illustrated act is provided for receiving audio signals from a set of audio inputs corresponding to a plurality of participants in a virtual meeting (act 910). Each audio signal includes a voice component and a background noise component.

Systems isolate the background noise component from the voice component for each received audio signal (act 920).

After isolating the different background noise components from each user, in some instances, systems determine an ambiance score for each isolated background noise component (act 930). When ambiance scores are used in selecting the background noise component, the ambiance score for each isolated background noise component is determined based on a desired context of the virtual meeting, in some instances. In some instances, determining the ambiance score for each isolated background noise component further includes: analyzing one or more attributes of each isolated background noise component and determining the ambiance score for each isolated background noise component is based on analyzing the one or more attributes of each isolated background noise component. For example, the one or more attributes of each of the isolated background noise components includes: volume stability, sound consistency, or absence of detectable and/or discernable words.

Based on the determined ambiance scores, systems then select a particular background noise component from the isolated background noise components (act 940). In some instances, selecting a particular background noise component from the isolated background noise components further includes: identifying a highest ambiance score from the determined ambiance scores; and selecting the particular background noise component with the highest ambiance score. The scoring and selection of the background noises can also include considerations of meeting and environmental contexts, as well as user inputs, as described above.

Finally, systems transmit the selected particular background noise component(s) to a set of audio outputs corresponding to the plurality of participants in order to provide a shared ambiance for the plurality of participants in the virtual meeting (act 950). In some instances, prior to transmitting the particular background noise component(s) to the set of audio inputs, the particular background noise component(s) will be amplified.

In some instances, systems modify the selected particular background noise component and determine a modified ambiance score for the modified particular background noise component. In response to determining that the modified ambiance score for the modified particular background noise component is higher than a previous ambiance score for the particular background noise component, the systems transmit the modified particular background noise component to the set of audio inputs.

The systems are configured to modify the background noise components according to different techniques describes herein. For example, in some instances, modifying the selected background noise component includes enhancing the selected background noise component to suppress some background noises in the selected background noise component while amplifying other background noises in the selected background noise component. Additionally, or alternatively, modifying the selected background noise component includes augmenting the selected background noise component with background noises not originally included in an audio signal corresponding to the selected background noise component.

In some embodiments, a mixed background noise component is generated as the shared ambiance audio. For example, systems determine a weighting scheme for the isolated background noise components, apply the weighting scheme to the isolated background noise components, combine the isolated background noise components based on the weighting scheme, generate a mixed background noise component based on combining the isolated background noise components, and transmit the mixed background noise component to the set of audio outputs.

In order to provide the shared ambiance in the virtual meetings, systems transmit a first voice component corresponding to a first participant to the plurality of audio outputs while transmitting the particular background noise component, identify a new voice component from a second participant, and switch to transmitting the new voice component from the second participant without modifying a transmission of the particular background noise component.

In some embodiments, the computing system further comprises a user interface configured to receive user input for modifying one or more of the isolated background noise components. In such embodiments, systems receive user input for modifying the particular background noise component and subsequently modify the particular background noise component based on the user input.

In some embodiments, the computing system employs machine learning in order to perform one or more of the acts described herein. For example, systems access a machine learning model trained to determine ambiance scores for background noises, generate new training data including the user input for modifying the particular background noise component, and train the machine learning model on the new training data to update one or more parameters of the machine learning model based on the user input.

In some instances, the computing system selects the machine learning model based on a desired context of the virtual meeting such that the ambiance score for each isolated background noise component is determined based on the desired context of the virtual meeting. In some instances, input to the machine learning includes one or more attributes of the background noise components such that the machine learning model analyzes the one or more attributes of each isolated background noise component and determines the ambiance score for each isolated background noise component based on analyzing the one or more attributes of each isolated background noise component.

Some embodiments are also directed to a personalized ambiance experience, in which each user is provided a continuous background noise component that is not interrupted, regardless of which user is speaking. In such embodiments, the selected particular background noise component referred to above is a first selected background noise component, wherein the computer-executable instructions are further executable by the processor to cause the computing system to: instead of transmitting the selected particular background noise component to the plurality of audio outputs, transmit the first selected background noise component to a first audio output corresponding to a first participant in the virtual meeting. Then, the systems select a second background noise component and transmit the second selected background noise component to a second audio output corresponding to a second participant in the virtual meeting. Thus, while background ambiance experience for the first participant is different from the second participant, the computing system maintains a continuous and personalized background ambiance experience for the first participant and second participant as the different participants contribute new voice components during the virtual meeting.

When curating a personalized ambiance experience for each user, the system, in some instances is configured to determine a personalized ambiance score for each participant in the virtual meeting and select the first selected background noise component and second selected background noise component based on the personalized ambiance score for each participant in the virtual meeting.

### Example Computing Systems

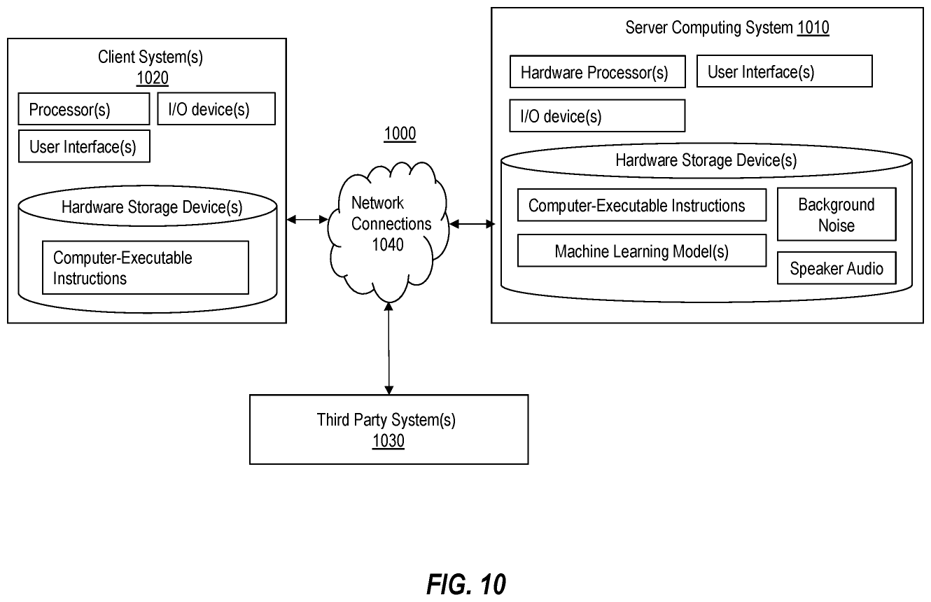

Attention will now be directed to FIG. 10, which illustrates the computing system 1010 as part of a computing environment 1000 that includes client system(s) 1020 and third-party system(s) 1030 in communication (via a network 1040) with the computing system 1010. As illustrated, computing system 1010 is a server computing system configured to compile, modify, and implement one or more machine learning models configured to provide a shared ambiance in a virtual meeting.

The computing system 1010, for example, includes one or more processor(s) (such as one or more hardware processor(s) and one or more hardware storage device(s) storing computer-readable instructions. One or more of the hardware storage device(s) is able to house any number of data types (e.g., background noise and/or speaker audio) and any number of computer-executable instructions by which the computing system 1010 is configured to implement one or more aspects of the disclosed embodiments when the computer-executable instructions are executed by the one or more hardware processor(s). The computing system 1010 is also shown including user interface(s) (representative of user interface 800) and input/output (I/O) device(s) (such as audio inputs like microphones and other audio input devices, and audio outputs such as speakers and other audio output devices).

As shown in FIG. 10, the hardware storage device(s) is shown as a single storage unit. However, it will be appreciated that the hardware storage device(s) is, a distributed storage that is distributed to several separate and sometimes remote systems and/or third-party system(s). Computing system 1010 can also comprise a distributed system with one or more of the components of computing system 1010 being maintained/run by different discrete systems that are remote from each other and each performs different tasks. In some instances, a plurality of distributed systems performs similar and/or shared tasks for implementing the disclosed functionality, such as in a distributed cloud environment.

The computing system is in communication with client system(s) 1020 comprising one or more processor(s), one or more user interface(s), one or more I/O device(s), one or more sets of computer-executable instructions, and one or more hardware storage device(s). In some instances, users of a particular software application (e.g., Microsoft Teams) engage with the software at the client system which transmits the background noise or speaker audio to the server computing system to be processed, wherein the audio-visual content from each user and the shared ambiance audio is transmitted to the user at a user interface at the client system. Alternatively, the server computing system is able to transmit instructions to the client system for generating and/or downloading machine learning models configured for performing the disclosed functionality and for facilitating the generation of shared ambiance audio in a virtual meeting.

The computing system is also in communication with third-party system(s). It is anticipated that, in some instances, the third-party system(s) 1030 further comprise databases housing data that could be used as training data, for example, background noises not included in local storage. Additionally, or alternatively, the third-party system(s) 1030 includes machine learning systems (e.g., AML endpoints) external to the computing system 1010.

Embodiments of the present invention may comprise or utilize a special-purpose or general-purpose computer (e.g., computing system 1010) including computer hardware, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media (e.g., hardware storage device(s) of FIG. 10) that store computer-executable/computer-readable instructions are physical hardware storage media/devices that exclude transmission media. Computer-readable media that carry computer-executable instructions or computer-readable instructions in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 1040 of FIG. 10) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special-purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

### Aspects of the Disclosed Embodiments

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

Various aspects of the present subject matter are set forth below, in review of, and/or in supplementation to, the embodiments described thus far, with the emphasis here being on the interrelation and interchangeability of the following embodiments related to either systems or methods disclosed herein. In other words, an emphasis is on the fact that each feature of the embodiments can be combined with each and every other feature unless explicitly stated otherwise or logically implausible.

In some aspects, the techniques described herein relate to a method for providing a shared ambiance in a virtual meeting, the method including: receiving audio signals from a set of audio inputs corresponding to a plurality of participants in a virtual meeting, each audio signal including a voice component and a background noise component; isolating the background noise component from the voice component for each received audio signal; optionally, determining an ambiance score for each isolated background noise component; based on the optional determined ambiance scores, selecting a particular background noise component from the isolated background noise components; and transmitting the particular background noise component to a set of audio outputs corresponding to the plurality of participants in order to provide a shared ambiance for the plurality of participants in the virtual meeting.

In some aspects, the techniques described herein relate to a method, wherein the ambiance score for each isolated background noise component is determined based on a desired context of the virtual meeting.

In some aspects, the techniques described herein relate to a method, wherein selecting a particular background noise component from the isolated background noise components further includes: identifying a highest ambiance score from the determined ambiance scores; and selecting the particular background noise component with the highest ambiance score.

In some aspects, the techniques described herein relate to a method, wherein determining the ambiance score for each isolated background noise component further includes: analyzing one or more attributes of each isolated background noise component; and determining the ambiance score for each isolated background noise component based on analyzing the one or more attributes of each isolated background noise component.

In some aspects, the techniques described herein relate to a method, wherein one or more attributes of each of the isolated background noise components include: volume stability, sound consistency, or absence of detectable and/or discernable words.

In some aspects, the techniques described herein relate to a method, further including: prior to transmitting the particular background noise component to the set of audio inputs, amplifying the particular background noise component. In some instances, the selected background component and the user's individual background component (if they are different) are mixed and transmitted through that user's audio output. Thus, for one or more participants, while transmitting the selected background component (which may or may not be amplified over the user's own background noise environment), the system mixes the particular background noise component with the background noise component corresponding to the one or more participants.

In some aspects, the techniques described herein relate to a method, further including: modifying the selected particular background noise component; determining a modified ambiance score for the modified particular background noise component; determining that the modified ambiance score for the modified particular background noise component is higher than a previous ambiance score for the particular background noise component; and transmitting the modified particular background noise component to the set of audio inputs.

In some aspects, the techniques described herein relate to a method, wherein modifying the selected background noise component includes enhancing the selected background noise component to suppress some background noises in the selected background noise component while amplifying other background noises in the selected background noise component.

In some aspects, the techniques described herein relate to a method, wherein modifying the selected background noise component includes augmenting the selected background noise component with background noises not originally included in an audio signal corresponding to the selected background noise component.

In some aspects, the techniques described herein relate to a method, further including: determining a weighting scheme for the isolated background noise components; applying the weighting scheme to the isolated background noise components; combining the isolated background noise components based on the weighting scheme; generating a mixed background noise component based on combining the isolated background noise components; and transmitting the mixed background noise component to the set of audio outputs.

In some aspects, the techniques described herein relate to a computing system for providing a shared ambiance in a virtual meeting, the computing system including: a plurality of audio input devices; a plurality of audio output devices; a processor; and a hardware storage device storing computer-executable instructions that are executable by the processor to cause the computing system to: receive audio signals from the plurality of audio inputs corresponding to a plurality of participants in a virtual meeting, each audio signal including a voice component and a background noise component; isolate the background noise component from the voice component for each received audio signal; determine an ambiance score for each isolated background noise component; based on the determined ambiance scores, select a particular background noise component from the isolated background noise components; and transmit the particular background noise component to the plurality of audio outputs corresponding to the plurality of participants in order to provide a shared ambiance for the plurality of participants in the virtual meeting.

In some aspects, the techniques described herein relate to a computing system, wherein the computer-executable instructions are further executable by the processor to further cause the computing system to: transmit a first voice component corresponding to a first participant to the plurality of audio outputs while transmitting the particular background noise component; identify a new voice component from a second participant; and switch to transmitting the new voice component from the second participant without modifying a transmission of the particular background noise component.

In some aspects, the techniques described herein relate to a computing system, further including: a user interface configured to receive user input for modifying one or more of the isolated background noise components.

In some aspects, the techniques described herein relate to a computing system, wherein the computer-executable instructions are further executable by the processor to further cause the computing system to: receive user input for modifying the particular background noise component; and modify the particular background noise component based on the user input.

In some aspects, the techniques described herein relate to a computing system, wherein the computer-executable instructions are further executable by the processor to further cause the computing system to: access a machine learning model trained to determine ambiance scores for background noises; generate new training data including the user input for modifying the particular background noise component; and train the machine learning model on the new training data to update one or more parameters of the machine learning model based on the user input.

In some aspects, the techniques described herein relate to a computing system, wherein the computing system selects the machine learning model based on a desired context of the virtual meeting such that the ambiance score for each isolated background noise component is determined based on the desired context of the virtual meeting.

In some aspects, the techniques described herein relate to a computing system, wherein the computing system determines the ambiance score for each isolated background noise component by: analyzing one or more attributes of each isolated background noise component; and determining the ambiance score for each isolated background noise component is based on analyzing the one or more attributes of each isolated background noise component.

In some aspects, the techniques described herein relate to a computing system, wherein the computing system selects the particular background noise component from the isolated background noise components by: identifying a highest ambiance score from the determined ambiance scores; and selecting the particular background noise component with the highest ambiance score.

In some aspects, the techniques described herein relate to a computing system, wherein the selected particular background noise component is a first selected background noise component, the computer-executable instructions being further executable by the processor to cause the computing system to: instead of transmitting the selected particular background noise component to the plurality of audio outputs, transmit the first selected background noise component to a first audio output corresponding to a first participant in the virtual meeting; select a second background noise component; and transmit the second selected background noise component to a second audio output corresponding to a second participant in the virtual meeting, wherein while background ambiance experience for the first participant is different from the second participant, the computing system maintains a continuous and personalized background ambiance experience for the first participant and second participant as different participants contribute new voice components during the virtual meeting.

In some aspects, the techniques described herein relate to a computing system, wherein the computer-executable instructions are further executable by the processor to further cause the computing system to: determine a personalized ambiance score for each participant in the virtual meeting; and select the first selected background noise component and second selected background noise component based on the personalized ambiance score for each participant in the virtual meeting.

It should be noted that all features, elements, components, functions, and steps described with respect to any embodiment provided herein are intended to be freely combinable and substitutable with those from any other embodiment. If a certain feature, element, function, or step is described with respect to only one embodiment, it should be understood that each feature, element, function, or step can be used with any other embodiment described herein.

What is claimed is:

1. A method for providing a shared ambiance audio in a virtual meeting, the method comprising:
receiving audio signals from a set of audio inputs corresponding to a plurality of participants in a virtual meeting, each audio signal comprising a voice component and a background noise component;
isolating the background noise component from the voice component for each received audio signal;
selecting a particular background noise component from the isolated background noise components; and
transmitting the particular background noise component to a set of audio outputs corresponding to the plurality of participants in order to provide a shared ambiance audio for the plurality of participants in the virtual meeting.

2. The method of claim 1, further comprising:
determining an ambiance score for each isolated background noise component, wherein selecting the particular background noise component from the isolated background noise components is based on the determined ambiance scores,

3. The method of claim 2, wherein selecting a particular background noise component from the isolated background noise components further comprises:
identifying a highest ambiance score from the determined ambiance scores; and
selecting the particular background noise component with the highest ambiance score.

4. The method of claim 1, wherein determining the ambiance score for each isolated background noise component further comprises:
analyzing one or more attributes of each isolated background noise component; and
determining the ambiance score for each isolated background noise component is based on analyzing the one or more attributes of each isolated background noise component.

5. The method of claim 4, wherein one or more attributes of each of the isolated background noise components comprises: volume stability, sound consistency, absence of detectable and/or discernable words, or an overall context of the virtual meeting.

6. The method of claim 1, further comprising:
for at least one participant, while transmitting the particular background noise component to the set of audio inputs, mixing the particular background noise component with the background noise component corresponding to the at least one participant.

7. The method of claim 1, further comprising:
modifying the selected particular background noise component;
determining a modified ambiance score for the modified particular background noise component;
determining that the modified ambiance score for the modified particular background noise component is higher than a previous ambiance score for the particular background noise component; and
transmitting the modified particular background noise component to the set of audio inputs.

8. The method of claim 7, wherein modifying the selected background noise component comprises enhancing the selected background noise component to suppress some background noises in the selected background noise component while amplifying other background noises in the selected background noise component.

9. The method of claim 7, wherein modifying the selected background noise component comprises augmenting the selected background noise component with background noises not originally included in an audio signal corresponding to the selected background noise component.

10. The method of claim 1, further comprising:
determining a weighting scheme for the isolated background noise components;
applying the weighting scheme to the isolated background noise components;
combining the isolated background noise components based on the weighting scheme;
generating a mixed background noise component based on combining the isolated background noise components; and
transmitting the mixed background noise component to the set of audio outputs.

11. A computing system for providing a shared ambiance audio in a virtual meeting, the computing system comprising:
a plurality of audio input devices;
a plurality of audio output devices;
a processor; and
a hardware storage device storing computer-executable instructions that are executable by the processor to cause the computing system to:
receive audio signals from the plurality of audio inputs corresponding to a plurality of participants in a virtual meeting, each audio signal comprising a voice component and a background noise component;
isolate the background noise component from the voice component for each received audio signal;
select a particular background noise component from the isolated background noise components; and
transmit the particular background noise component to the plurality of audio outputs corresponding to the plurality of participants in order to provide a shared ambiance audio for the plurality of participants in the virtual meeting.

12. The computing system of claim 11, wherein the computer-executable instructions are further executable by the processor to further cause the computing system to:
transmit a first voice component corresponding to a first participant to the plurality of audio outputs while transmitting the particular background noise component;
identify a new voice component from a second participant; and
switch to transmitting the new voice component from the second participant without modifying a transmission of the particular background noise component.

13. The computing system of claim 11, further comprising:
a user interface configured to receive user input for modifying one or more of the isolated background noise components.

14. The computing system of claim 11, wherein the computer-executable instructions are further executable by the processor to further cause the computing system to:
receive user input for modifying the particular background noise component; and
modify the particular background noise component based on the user input.

15. The computing system of claim 14, wherein the computer-executable instructions are further executable by the processor to further cause the computing system to:
access a machine learning model trained to determine ambiance scores for background noises;
generate new training data comprising the user input for modifying the particular background noise component; and
train the machine learning model on the new training data to update one or more parameters of the machine learning model based on the user input.

16. The computing system of claim 15, wherein the computing system selects the machine learning model for determining ambiance scores based on a desired context of the virtual meeting such that an ambiance score for each isolated background noise component is determined based on the desired context of the virtual meeting.

17. The computing system of claim 15, wherein the computing system further determines an ambiance score for each isolated background noise component by:
analyzing one or more attributes of each isolated background noise component; and
determining an ambiance score for each isolated background noise component based on analyzing the one or more attributes of each isolated background noise component.

18. The computing system of claim 16, wherein the computing systems selects the particular background noise component from the isolated background noise components by:
identifying a highest ambiance score from the determined ambiance scores; and
selecting the particular background noise component with the highest ambiance score.

19. The computing system of claim 11, wherein the selected particular background noise component is a first selected background noise component, the computer-executable instructions being further executable by the processor to cause the computing system to:
instead of transmitting the selected particular background noise component to the plurality of audio outputs, transmit the first selected background noise component to a first audio output corresponding to a first participant in the virtual meeting;
select a second background noise component; and
transmit the second selected background noise component to a second audio output corresponding to a second participant in the virtual meeting, wherein while background ambiance experience for the first participant is different from the second participant, the computing system maintains a continuous and personalized background ambiance experience for the first participant and second participant as different participants contribute new voice components during the virtual meeting.

20. The computing system of claim 19, wherein the computer-executable instructions are further executable by the processor to further cause the computing system to:
determine a personalized ambiance score for each participant in the virtual meeting; and
select the first selected background noise component and second selected background noise component based on the personalized ambiance score for each participant in the virtual meeting.
